(19) United States
(12) Patent Application Publication
(10) Pub. No.: US 2017/0044804 A1
(43) Pub. Date: Feb. 16, 2017

(54) KEY HANDLE WITH CODABLE LOCK CORE FOR TRUCK CAP APPLICATION

(71) Applicant: TRUCK ACCESSORIES GROUP, LLC, Elkhart, IN (US)

(72) Inventors: EUGENE A. DYLEWSKI, II, GRANGER, IN (US); ERNEST M. McDONALD, II, GRANGER, IN (US)

(21) Appl. No.: 15/235,476

(22) Filed: Aug. 12, 2016

Related U.S. Application Data
(60) Provisional application No. 62/204,755, filed on Aug. 13, 2015.
(60) Provisional application No. 62/248,701, filed on Oct. 30, 2015.

(51) Int. Cl. E05B 79/06; E05B 63/00; E05B 13/10; E05B 83/16; E05B 85/10

(52) U.S. Cl. CPC E05B 79/06; E05B 83/16; E05B 85/10; E05B 13/106; E05B 63/0056; B60J 7/106

(57) ABSTRACT

A T-handle assembly that attaches to a truck accessory is provided. The T-handle assembly includes a handle and a base. The handle further includes a grippable body portion and a first neck portion extending transversely from the grippable body portion. The grippable body portion and the first neck portion both include a bore that extends there through to receive a lock set cylinder. The base includes a planar base portion that extends transversely from a second neck portion that extends from the planar base portion.

### RELATED APPLICATIONS

The present application relates to and claims priority to U.S. Provisional Patent Application, Ser. No. 62/204,755, filed on Aug. 13, 2015, entitled “Key Handle With Codable Lock Core for Truck Cap Application” and 62/248,701, filed on Oct. 30, 2015, entitled “Key Handle With Codable Lock Core for Truck Cap Application-2.” The subject matter disclosed in those provisional patent applications are hereby expressly incorporated into the present application.

### TECHNICAL FIELD AND SUMMARY

The present disclosure relates to truck accessories and, in particular, to pickup truck bed cover accessories such as a truck cap or tonneau cover having an improved keyed T-handle.

Vehicles such as a pickup truck and the like typically include a single original equipment manufacturer (OEM) key configured to operate both the door locks and engage the ignition. Truck bed covers or caps typically include a lockable latched hatch, sliding or swing door, that selectively provides access to the bed. This door, typically located at the rear or side of the truck, is lockable with a key as well. Conventionally, because pickup truck caps are aftermarket products, meaning they are installed on the truck by a third party vendor and not OEM, they are locked using an aftermarket lock and cylinder key system. This translates into the operator having two keys for the vehicle, one for the truck itself and a second for the cap door.

In addition, these cap doors are typically latched and unlatched using an operable handle attached thereto. This handle is in proximity to the truck's own tailgate that may also be locked using the OEM lock cylinder key. Again, this means that two key cylinders are in close proximity of each other, but require separate keys to lock and unlock each one. This is both inconvenient and inefficient.

It is appreciated that aftermarket key cylinders codable to OEM truck keys are known. Such key cylinder cores configured to code to the OEM key may be provided by Strattec Security Corporation, Milwaukee, Wis. Examples of such key cylinders may be found in U.S. Pat. Nos. 7,047,778 and 7,634,930, the disclosures of which are incorporated herein by reference.

Because a typical OEM key cylinder is larger than an aftermarket T-handle (and the like) key cylinder a problem is created. This larger key cylinder requires a longer key-handle in order to accommodate it. This means the T-handle assembly may stick out even farther from the accessory door, window, or cap than when using conventional aftermarket key cylinders. This poses an aesthetic challenge because such a look may be undesirable.

An illustrative embodiment of the present disclosure provides a handle assembly configured to attach to a truck cap that is configured to latch, unlatch, and a truck cap door, window, or windoor. In addition, the handle assembly includes a lock cylinder that may be coded with an OEM key used for the vehicle itself so that a single OEM key not only locks and unlocks all the doors on the truck, but locks and unlocks the aftermarket truck cap door as well. In an embodiment, keying the truck cap lock cylinder with the OEM key may be accomplished during or after installation of the aftermarket cap. In other words, a purchaser of an aftermarket truck cap may have the cap installed and then use whatever OEM key that came with the truck to code that cap's lock with the truck's OEM key.

In another illustrative embodiment, a portion of a T-handle body may extend through a portion of a T-handle base and into the frame or panel of the truck cap, cover door, or window (or windoor). By extending a portion of the actual handle assembly of the T-handle into the base, it may now accommodate larger key cylinders without having the handle extend from the door a length otherwise necessary. Even further, employing the larger lock cylinder with a recessed handle body may allow a portion of the cylinder to extend through the truck cap door frame or panel. This may produce a stronger latching feature. The spindle may extend from the cylinder starting at a point in the door frame beyond the exterior side of the T-handle base. In this embodiment, the codable lock core extends through the handle, into the handle's base, and into the frame. It is believed that may add strength to the handle in addition to creating a lower profile.

It is also appreciated that the key cylinder core on the handle may be removable to accommodate key cylinder cores from different auto manufacturers. For example, the handle may be configured to receive a key cylinder that fits all of General Motors' keys. Conversely, the handle may accept an alternative key cylinder that accepts all of Nissan's truck keys. This same principle applies to the other auto manufacturers as well.

Another illustrative embodiment of the present disclosure provides a T-handle assembly that attaches to a truck accessory selected from the group consisting of a cap and tonneau cover. The T-handle includes a handle and a base. The handle further includes a grippable body portion and a first neck portion extending transversely from the grippable body portion. The grippable body portion and the first neck portion both include a first bore that extends there through. A lockset cylinder extends through the grippable body portion and into the first neck portion. The base includes a planar base portion that extends transversely from a second neck portion which extends from the planar base portion opposite the first neck portion and coaxial with the first neck portion. The planar base portion and the second neck portion both include a second bore that extends there through. The first neck portion of the grippable body portion is disposed coaxially into the second neck portion such that the lockset cylinder extends into the first bore through the grippable body portion and the first neck portion. Additionally, the first neck portion also extends into the second neck portion of the planar base portion. A latch spindle coaxially aligned with the lockset cylinder and extends through the second neck portion but not through the first neck portion. The handle may also be rotatable with respect to the base.

In the above and other illustrative embodiments, the T-handle assembly may further comprise: the second neck portion extending through a frame of the truck accessory; the second neck portion extending through a panel of the truck accessory; the second neck portion extending through a window of the truck accessory; a base cap that shrouds the second neck portion opposite the handle; a portion of the base cap that shrouds the second neck portion being spaced apart from the second neck portion; and a latch spindle neck that extends from the second neck portion and through the base cap.

Another illustrative embodiment of the present disclosure provides a T-handle assembly that attaches to a truck accessory selected from the group consisting of a cap and tonneau cover. The T-handle again includes a handle and a base. The handle further includes a grippable body portion and a first neck portion extending transversely from the grippable body portion. The grippable body portion and the first neck portion both include a first bore that extends there through. The base includes a planar base portion that extends transversely from a second neck portion. The second neck portion extends from the planar base portion opposite the first neck portion and coaxial with the first neck portion. The planar base portion and the second neck portion both include a second bore that extends there through. The first neck portion of the grippable body portion is disposed coaxially into the second neck portion and the first neck portion. Additionally, the first neck portion also extends into the second neck portion of the planar base portion.

In the above and other illustrative embodiments, the T-handle assembly may further comprise: the second neck portion extending through a frame of the truck accessory; the second neck portion extending through a panel of the truck accessory; the second neck portion extending through a window of the truck accessory; a lock cylinder fitting into the bore that extends through the handle and the base; the lockset cylinder extending through the grippable body portion and into the first neck portion; the first neck portion of the grippable body portion being disposed coaxially into the second neck portion such that the lockset cylinder extends into the first bore through the grippable body portion and the first neck portion and; a latch spindle coaxially aligned with the lockset cylinder and extends through the second neck portion but not through the first neck portion.

Another illustrative embodiment of the present disclosure provides a T-handle assembly that attaches to a truck accessory door. The T-handle assembly again includes a handle and a base. The handle includes a grippable body portion and a first neck portion that extends transversely from the grippable body portion. The grippable body portion and the first neck portion both include a first bore that extends there through. The base includes a planar base portion that extends transversely from a second neck portion. The second neck portion extends from the planar base portion opposite the first neck portion and coaxial with the first neck portion. The planar base portion and the second neck portion both include a second bore that extends there through. The first neck portion of the grippable body portion is disposed coaxially into the second neck portion and the first neck portion. Also, the first neck portion extends into the second neck portion of the planar base portion. A latch spindle is coaxially aligned with the first neck portion and extends through the second neck portion but not through the first neck portion.

In the above and other illustrative embodiments, the T-handle assembly may further comprise: a lock cylinder that fits into the bore that extends through the handle and the base; the lockset cylinder extends through the grippable body portion and into the first neck portion; and the first neck portion of the grippable body portion is disposed coaxially into the second neck portion such that the lockset cylinder extends into the first bore through the grippable body portion and the first neck portion.

Additional features of the present disclosure will become apparent to those skilled in the art upon consideration of illustrative embodiments including the best mode of carrying out the disclosure as presently perceived.

### DESCRIPTION OF THE DRAWINGS

The present disclosure will be described hereafter with reference to the attached drawings which are given as non-limiting examples.

FIG. 1 is an exterior detail-perspective view of a portion of a truck cap door frame assembly with a T-handle assembly disposed thereon;

FIG. 2 is another exterior detail-perspective view of the truck cap door frame assembly with the T-handle assemble disposed thereon;

FIG. 3 is a cross-sectional detail-perspective view of the truck cap door frame assembly with the T-handle assembly disposed thereon;

FIG. 4 is a cross-sectional detail top view of a portion of the truck cap door frame assembly with the T-handle assembly disposed thereon;

FIG. 5 is a perspective view of the T-handle assembly;

FIG. 6 is a side elevation view of the T-handle assembly;

FIG. 7 is a front perspective view of another illustrative embodiment of a T-handle assembly;

FIG. 8 is a rear perspective view of the T-handle assembly of FIG. 7; and

FIG. 9 is a cross-sectional perspective view of a windoor assembly with the T-handle assembly disposed thereon.

### DETAILED DESCRIPTION

The figures and descriptions provided herein may have been simplified to illustrate aspects that are relevant for a clear understanding of the herein described structures, while eliminating, for the purpose of clarity, other aspects that may be found in typical structures. Those of ordinary skill may recognize that other elements and/or operations may be desirable and/or necessary to implement the structures described herein. Because such elements and operations would be known in the art, and because they do not facilitate a better understanding of the present disclosure, a discussion of such elements and operations may not be provided herein. The present disclosure, however, is deemed to inherently include all such elements, variations, and modifications to the described aspects that would be known to those of ordinary skill in the art.

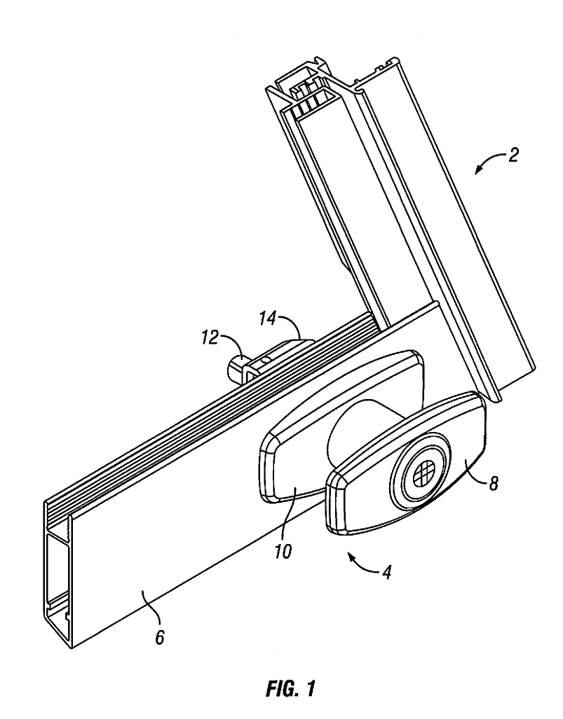

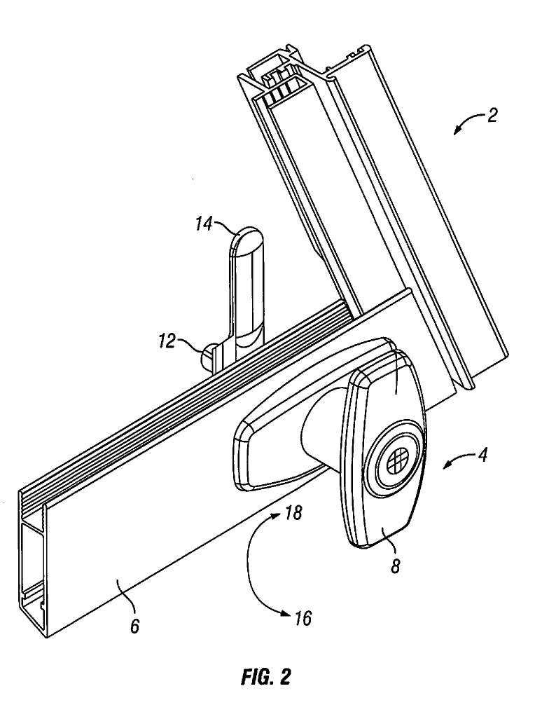

Exterior detail perspective views of a portion of a truck cap door frame assembly 2 with a T-handle assembly 4 disposed through frame member 6 in latched and unlatched conditions are shown in FIGS. 1 and 2, respectively. Although cap door frame assembly 2 is the illustrative recipient of T-handle assembly 4, it is appreciated that such T-handles may be used on truck or pick-up truck accessories such as truck caps, tonneau covers, windoors, accessory boxes, and the like. The use of truck cap door frame assembly 2 shown herein is for illustrative purposes. With respect to T-handle assembly 2, it includes a handle portion 8 that is pivotable with respect to a base portion 10 to rotate a spindle 12 that likewise rotates latch member 14 between latched and unlatched conditions. As shown herein, handle portion 8 may be rotated in directions 16 and 18 to pivot latch member 14 to its unlatched or latched positions as particularly shown in these views.

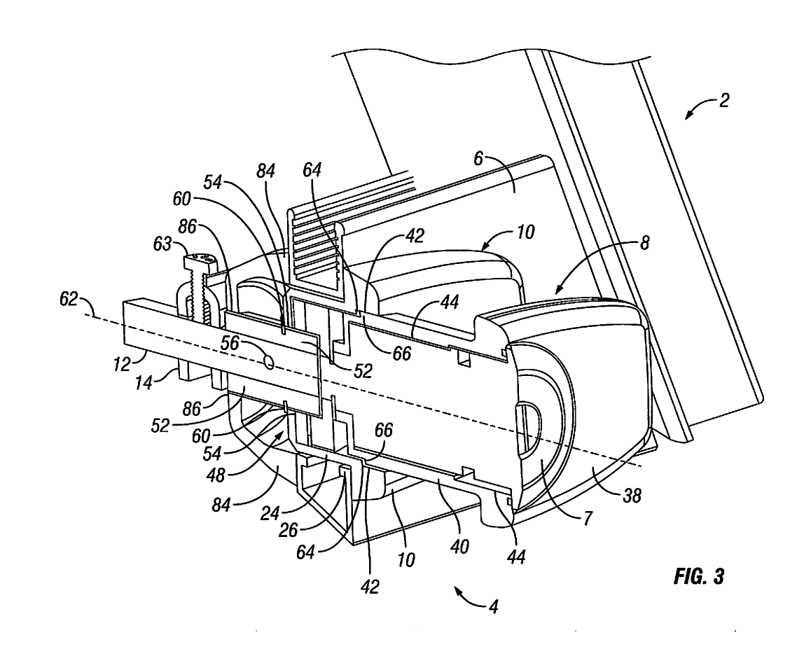

A detailed cross-sectional perspective view of truck cap door frame assembly 2 is shown in FIG. 3. T-handle assembly 4 is shown with latch member 14 illustratively located in the latched position. This view, in particular, shows a lower base neck portion 24 of base portion 10 extending through a bore 26 in frame member 6. Spindle 12 extends from lower base neck portion 24 with latch member 14 spaced apart from frame member 6.

The cross-sectional view of T-handle assembly 4 shown in FIG. 3 demonstrates the distinctive construction of the same. For example, with respect to handle portion 8, it comprises not only a grippable body 38 but also its own handle neck 40 that extends into base bore 42 of base portion 10. Handle portion 8 also includes its own lock cylinder bore 44 configured to receive codable lock cylinder 7 as shown. It can be appreciated from this view the extent to which codable lock cylinder 7 extends through T-handle assembly 4 and into base portion 10.

At a distal end 48 of lower base neck portion 24 of base portion 10, a cavity 34 is located in bore 26 of frame 6. Cavity 34 includes a spindle neck 52 that is configured to extend out from opening 54 of lower base neck portion 24 of base portion 10. It is appreciated from this view that handle portion 8 is rotatable with respect to base portion 10 and lower base neck portion 24. Spindle 12 is attached to handle neck 40 illustratively at spindle neck 52 via an illustrative friction fit pin 56. Further evident from this view is the alignment of codable lock cylinder 7 inside handle portion 8 coaxial with spindle 12 along axis 62. Pivoting handle portion 8 in directions 16 or 18, as discussed previously with regard to FIGS. 1 and 2, is done so about axis 62. A retaining ring 60 is located at distal end 48 on lower base neck portion 24 to rotatably secure handle portion 8 onto base portion 10. Also shown in this view is base cap 84 that may be used to shroud lower base neck portion 24 and retaining ring 60. Spindle neck 52 and spindle 12 extend through an opening 86 in base cap 84 which assists providing a more finished look to the door assembly as a whole.

To assist facilitating rotating handle portion 8, an O-ring 64 is fitted in an O-ring space 66 located at the periphery of handle neck 40 and base bore 42. This also maintains a seal that segregates the interior of T-handle assembly 4 with the exterior environment. It is further appreciated from this view how codable lock cylinder 7 extends through lock cylinder bore 44 and base portion 10. Also shown is fastener 63 that attaches latch member 14 to spindle 12.

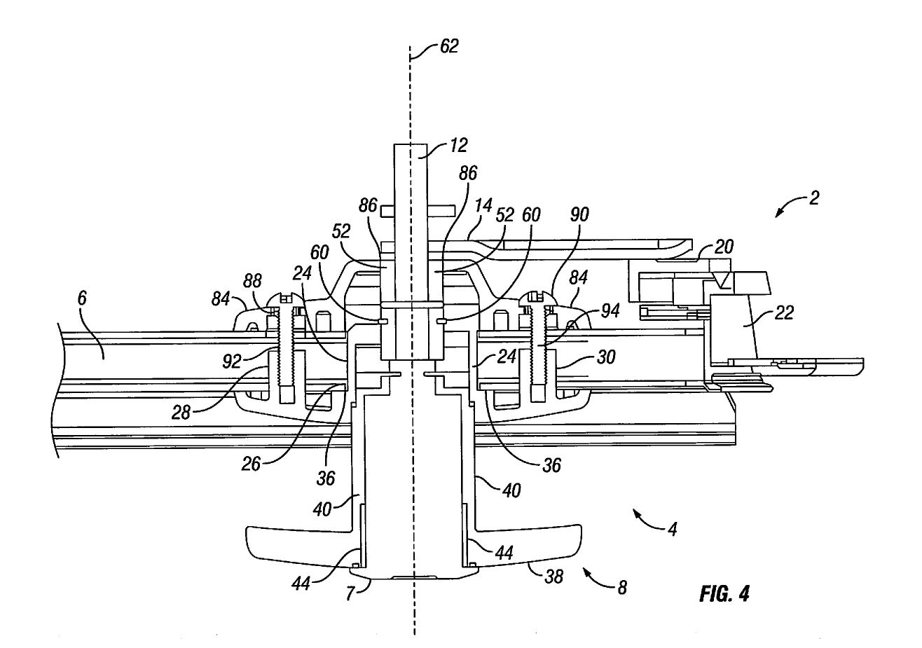

A top cross-sectional detail view of a portion of truck cap door frame assembly 2 with T-handle assembly is shown in FIG. 4. This view further demonstrates how T-handle 4 extends through frame 6. As shown, lower base neck portion 24 extends through bore 26 of frame member 6. Spindle 12 extends from lower base neck portion 24 and holds latch member 14 so that rotating handle portion 8 rotates latch member 14. Furthering the cross-sectional view of T-handle assembly 4 shown in FIG. 3, the view in FIG. 4 depicts base cap 84 including apertures 88 and 90 that receive fasteners 92 and 94, respectively, to attach base cap 84 to base portion 10. Particularly, fastener bosses 28 and 30 extending from lower side 36 of base portion 10 in the same direction as lower base neck portion 24, receive fasteners 92 and 94 illustratively as shown. Frame 6, is therefore, sandwiched between base portion 10 and base cap 84. In addition, base cap 84 shrouds lower base neck portion 24 and retaining ring 60. In this view latch member 14 is also shown engaging a latch plate 20 on interior of frame member 22.

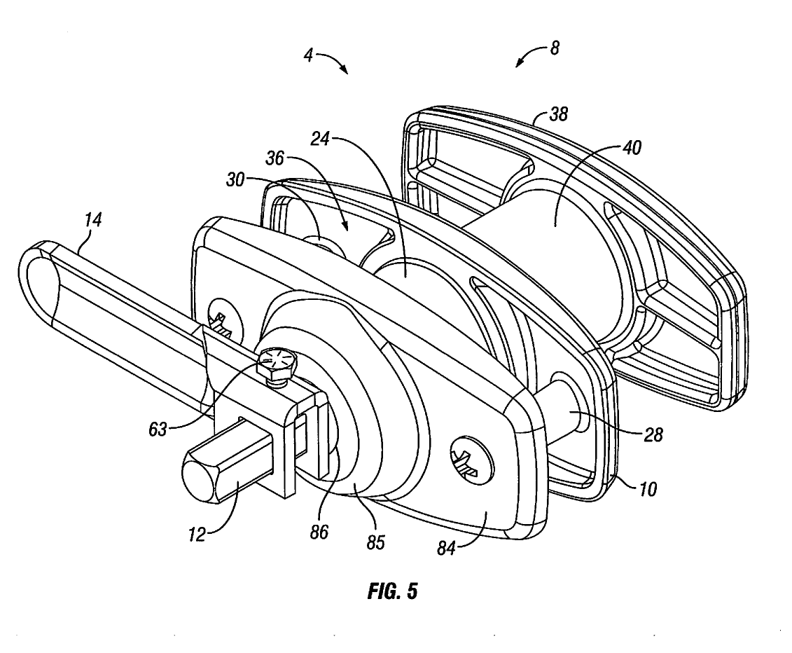

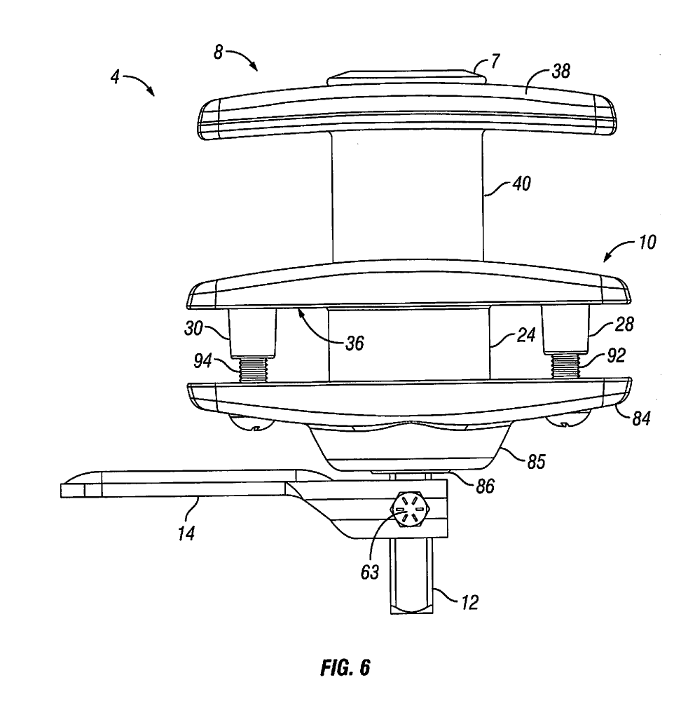

Perspective and elevation side views of T-handle assembly 4 are shown in FIGS. 5 and 6. These views isolate T-handle assembly 4 to better view its components. As shown in FIG. 5 for example, handle portion 8 includes grippable body 38 with handle neck 40 extending therefrom. Grippable portions 38 and handle neck 40 are configured to rotate with respect to base portion 10 that itself remains stationary. To that end, base portion 10 includes lower base neck portion 24 as well as fastener bosses 28 and 30 extending from lower side 36. As previously discussed, lower base neck portion 24 may receive a portion of handle neck 40 which contains codable lock cylinder 7. Base cap 84 is illustratively sized about the same as base portion 10 and both are configured to help sandwich a door frame, sliding panel, or windoor. Base cap 84 includes an illustrative bump-out 85 configured to accommodate lower base neck portion 24 of base portion 10 when disposed through a door frame such as that shown in FIGS. 1 through 4. Spindle 12 exiting from opening 86 of bump-out 85 attaches to pivoting latch member 14 via fastener 63.

The side elevation view shown in FIG. 6 depicts the same structures previously discussed while also helping demonstrate how much of the T-handle assembly body structure is located below lower surface 36 of base portion 10. It is believed this may increase stability and possibly strength to the T-handle assembly as well as reduce the extent to which handle portion 8 must otherwise extend from a door frame due to the relative increased size of codable lock cylinder 7.

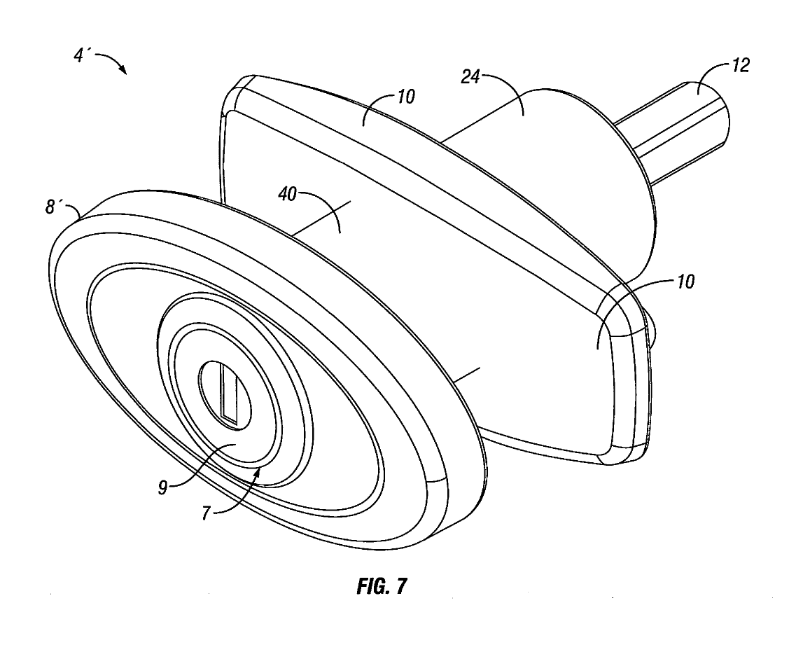

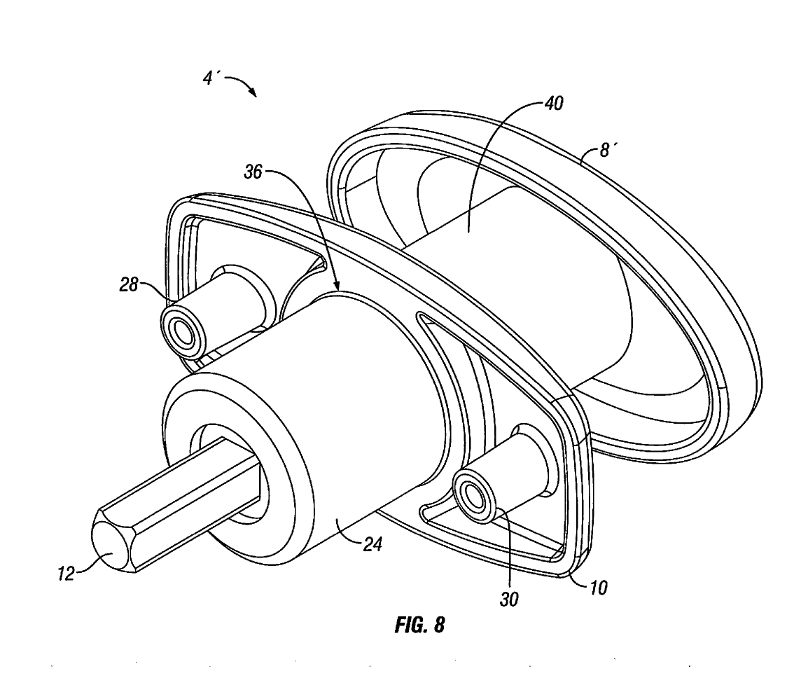

Front and rear perspective views of illustrative T-handle assembly 4′ are shown in FIGS. 7 and 8, respectively. This embodiment is a variant of T-handle assembly 4 because handle portion 8′ has an oval profile in contrast to the shape shown in the prior embodiment. Codable lock cylinder 7 includes a face 9 that is exposed on handle portion 8′ same as with handle 8. Handle neck 40 is still located opposite lower base neck portion 24 with base portion 10 positioned there between. Spindle 12 is shown extending from lower base neck portion 24. The reverse perspective view shown in FIG. 7 further depicts handle neck 40 extending from one side of base portion 10 and lower base neck portion 24 extending from the opposite side.

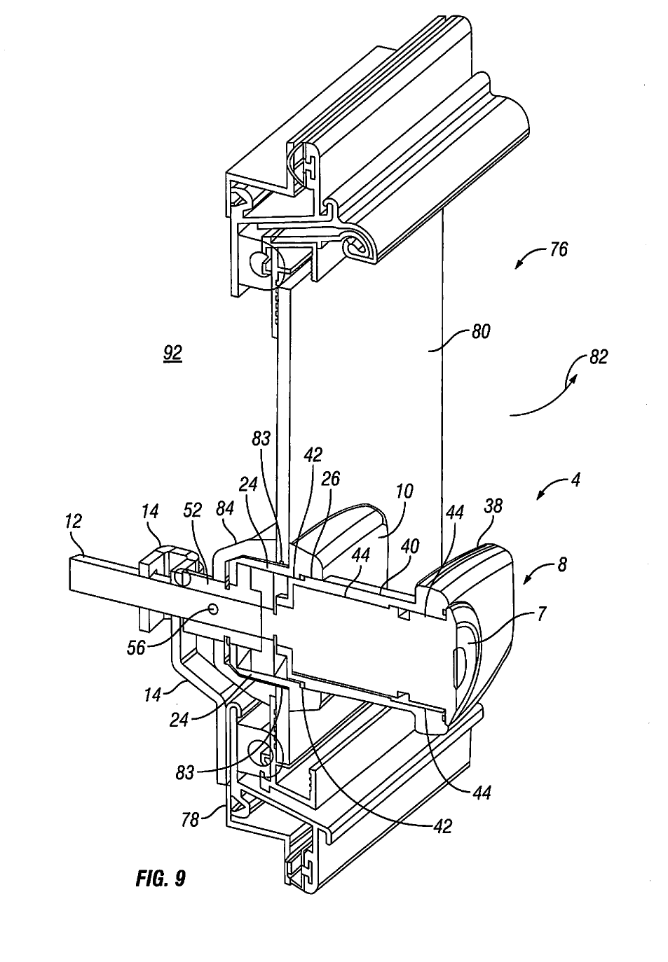

A perspective cross-sectional view of T-handle assembly 4 attached to a windoor assembly 76 and latched to frame 78 is shown in FIG. 9. Here, windoor 76 is primarily composed of a pane of glass or plexiglass 80 through which T-handle assembly 4 extends. Latch member 14 is configured to engage frame 78 when latching. This prevents windoor 76 from opening in direction 82 until T-handle assembly rotates latch member 14 clearing same from frame 78. This view also demonstrates the extent to which T-handle assembly 4 extends through window pane 80. Again, as previously discussed, because of the relative large size of codable lock cylinder 7, the T-handle needs to be larger and longer. But extending the T-handle body further out from the door may be esthetically undesirable. Furthermore, extending more of handle portion 8 through window pane 80 (or a door frame) and into lower base neck portion 24, may create a solid and secure T-handle assembly 4. As shown here, similar to that shown previously, base cap 84 shrouds lower base neck portion 24. This view further depicts an illustrative configuration of latch member 14 and how it may be bent or adjusted to accommodate the further extension of T-handle assembly 4 into interior side 92 of windoor 76.

Similar to that shown in FIG. 3, the cross-sectional view of T-handle assembly 4 in FIG. 9 is shown with latch member 14 illustratively located in the latched position. Lower base neck portion 24 of base portion 10 extends through bore 83 in pane 80. Grippable body 38 and handle neck 40 extends into base bore 42 of base portion 10. Handle portion 8 is also shown with lock cylinder bore 44 configured to receive codable lock cylinder 7. Base cap 84 along with base portion 10 sandwiches pane 80 to secure T-handle assembly 4 to same. This view also shows spindle 12 extending from spindle neck 52 and attached via pin 56. Also shown is latch member 14 attached to spindle 12 and angled back towards frame 78 to provide the latching function when handle portion 8 is rotated relative to base portion 10.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure.

What is claimed:

1. A T-handle assembly that attaches to a truck accessory selected from the group consisting of a cap and tonneau cover, the T-handle assembly comprises:
a handle that includes a grippable body portion and a first neck portion extending transversely from the grippable body portion;
wherein the grippable body portion and the first neck portion both include a first bore that extends there through;
a lockset cylinder that extends through the grippable body portion and into the first neck portion;
a base having a planar base portion that extends transversely from a second neck portion;
wherein the second neck portion extends from the planar base portion opposite the first neck portion and coaxial with the first neck portion;
wherein the planar base portion and the second neck portion both include a second bore that extends there through;
wherein the first neck portion of the grippable body portion is disposed coaxially into the second neck portion such that the lockset cylinder extends into the first bore through the grippable body portion and the first neck portion which also extends into the second neck portion of the planar base portion; and
a latch spindle coaxially aligned with the lockset cylinder and extends through the second neck portion but not through the first neck portion; and
wherein the handle is rotatable with respect to the base.

2. The T-handle assembly of claim 1, wherein the second neck portion extends through a frame of the truck accessory.

3. The T-handle assembly of claim 1, wherein the second neck portion extends through a panel of the truck accessory.

4. The T-handle assembly of claim 1, wherein the second neck portion extends through a window of the truck accessory.

5. The T-handle assembly of claim 1, further comprising a base cap that shrouds the second neck portion opposite the handle.

6. The T-handle assembly of claim 5, wherein a portion of the base cap that shrouds the second neck portion is spaced apart from the second neck portion.

7. The T-handle assembly of claim 6, further comprising a latch spindle neck that extends from the second neck portion and through the base cap.

8. A T-handle assembly that attaches to a truck accessory selected from the group consisting of a cap and tonneau cover, the T-handle assembly comprises:
a handle that includes a grippable body portion and a first neck portion extending transversely from the grippable body portion;
wherein the grippable body portion and the first neck portion both include a first bore that extends there through;
a base having a planar base portion that extends transversely from a second neck portion;
wherein the second neck portion extends from the planar base portion opposite the first neck portion and coaxial with the first neck portion;
wherein the planar base portion and the second neck portion both include a second bore that extends there through; and
wherein the first neck portion of the grippable body portion is disposed coaxially into the second neck portion and the first neck portion also extends into the second neck portion of the planar base portion.

9. The T-handle assembly of claim 8, wherein the second neck portion extends through a frame of the truck accessory.

10. The T-handle assembly of claim 8, wherein the second neck portion extends through a panel of the truck accessory.

11. The T-handle assembly of claim 8, wherein the second neck portion extends through a window of the truck accessory.

12. The T-handle assembly of claim 8, further comprising a lock cylinder that fits into the bore that extends through the handle and the base.

13. The T-handle assembly of claim 12, wherein the lockset cylinder extends through the grippable body portion and into the first neck portion.

14. The T-handle assembly of claim 13, wherein the first neck portion of the grippable body portion is disposed coaxially into the second neck portion such that the lockset cylinder extends into the first bore through the grippable body portion and the first neck portion.

15. The T-handle assembly of claim 14, further comprising a latch spindle coaxially aligned with the lockset cylinder and extends through the second neck portion but not through the first neck portion.

16. A T-handle assembly that attaches to a truck accessory door, the T-handle assembly comprising:
a handle that includes a grippable body portion and a first neck portion extending transversely from the grippable body portion;
wherein the grippable body portion and the first neck portion both include a first bore that extends there through;
a base having a planar base portion that extends transversely from a second neck portion;
wherein the second neck portion extends from the planar base portion opposite the first neck portion and coaxial with the first neck portion;
wherein the planar base portion and the second neck portion both include a second bore that extends there through;
wherein the first neck portion of the grippable body portion is disposed coaxially into the second neck portion and the first neck portion also extends into the second neck portion of the planar base portion; and
a latch spindle coaxially aligned with the first neck portion and extends through the second neck portion but not through the first neck portion.

17. The T-handle assembly of claim 16, further comprising a lock cylinder that fits into the bore that extends through the handle and the base.

18. The T-handle assembly of claim 17 wherein the lockset cylinder extends through the grippable body portion and into the first neck portion.

19. The T-handle assembly of claim 18, wherein the first neck portion of the grippable body portion is disposed coaxially into the second neck portion such that the lockset cylinder extends into the first bore through the grippable body portion and the first neck portion.
